(19) United States
(12) Patent Application Publication
(10) Pub. No.: US 2012/0051608 A1
(43) Pub. Date: Mar. 1, 2012

(54) SYSTEM AND METHOD FOR ANALYZING AND VISUALIZING LOCAL CLINICAL FEATURES

(76) Inventors: Gopal Biligeri Avinash, Menomonee Falls, WI (US); Ananth P. Mohan, Waukesha, WI (US)

(21) Appl. No.: 12/870,314

(22) Filed: Aug. 27, 2010

(51) Int. Cl. G06K 9/00

(52) U.S. Cl. 382/128

(57) ABSTRACT

A system and method for analyzing and visualizing local clinical features includes identification of a first region of interest (ROI) from a medical image dataset acquired from a patient and extraction of a feature dataset representing a feature of interest specific to the ROI. The system also includes identification of a second ROI from the medical image dataset, extraction of a reference dataset comprising reference data representing an expected behavior of the feature of interest, comparison of the feature dataset to the reference dataset, generation of a deviation metric representing a deviation of the feature of interest based on the comparison, and creation of a visual representation of the deviation metric.

### BACKGROUND OF THE INVENTION

Embodiments of the invention relate generally to diagnostic imaging and, more particularly, to a system and method for analyzing and visualizing local clinical features.

Complex medical conditions and diseases, such as Alzheimer's disease or lung cancer, for example, are difficult to detect and monitor at an early state. These complex diseases are also difficult to quantify in a standardized manner for comparison with a baseline, such as data acquired from a standardized reference population.

In response to these difficulties, investigators have developed methods to determine statistical deviations from normal patient populations. For example, one element of the detection of neurodegenerative disorders (NDDs) is the development of age and tracer segregated normal databases. Comparison to these normals can only happen in a standardized domain, e.g., the Talairach domain or the Montreal Neurological Institute (MNI) domain. The MNI defines a standard brain by using a large series of magnetic resonance imaging (MRI) scans on normal controls. The Talairach domain references a brain that is dissected and photographed for the Talairach and Tournoux atlases. In both the Talairach domain and the MNI domain, data must be mapped to the respective standard domain using registration techniques. Current methods that use a variation of the above method include tracers NeuroQ®, Statistical Parametric matching (SPM), 3D-sterotactic surface projections (3D-SSP), and so forth.

Once a comparison has been made, an image representing a statistical deviation of the anatomy is displayed, allowing a viewer to make a diagnosis based on the image. Making such a diagnosis is a very specialized task and is typically performed by highly-trained medical image experts. However, even such experts can only make a subjective call as to the degree of severity of the disease. Due to this inherent subjectivity, the diagnoses tend to be inconsistent and non-standardized.

Current research literature makes it increasingly clear that clinicians must be able to view and analyze a wide variety of diverse clinically-derived parameters in an efficient manner so that they can make informed decisions. However, traditional methods make it difficult for a clinician to analyze the increasingly vast amount of clinical data acquired and interpret it in a meaningful way. While automated algorithms and decision-support software applications have been developed to aid in image analysis, the accuracy of the output from these algorithms and applications is difficult to verify in practice. Further, these automated algorithms typically involve a “black-box” approach to decision-making where image data is the input to the algorithm and a final decision is the output. Thus, these algorithms afford a clinician little opportunity to interact with and understand the inner-workings of the algorithm.

Accordingly, there is a need for a methodology to visualize clinically derived characteristics of a region of interest of an image with respect to a reference dataset, such that a clinician can easily assimilate relevant information at a glance.

Therefore, it would be desirable to design a system and method of analyzing and visualizing characteristics of local features in image data that overcomes the aforementioned drawbacks.

### BRIEF DESCRIPTION OF THE INVENTION

In accordance with one aspect of the invention, a computer readable storage medium has stored thereon a computer program that includes instructions, which, when executed by a computer, cause the computer to access a medical image dataset acquired from a patient and identify a first region of interest (ROI) from the medical image dataset. The instructions also cause the computer to extract a feature dataset representing a feature of interest specific to the ROI, identify a second region of interest (ROI) from the medical image dataset, and extract a reference dataset comprising reference data representing an expected behavior of the feature of interest. Further, the instructions cause the computer to compare the feature dataset to the reference dataset, generate a deviation metric representing a deviation of the feature of interest based on the comparison, and create a visual representation of the deviation metric.

In accordance with another aspect of the invention, a method includes the steps of accessing a clinical image dataset comprising image data acquired from a patient, identifying a first ROI from the clinical image dataset, and defining a first ROI dataset comprising image data corresponding to the first ROI. The method also includes the steps of extracting at least one derived characteristic of interest corresponding to the first ROI from the first ROI dataset, defining a characteristic dataset comprising image data representing the at least one derived characteristic of interest, and identifying a second ROI from the clinical image dataset. The method further includes the steps of defining a second ROI dataset comprising image data corresponding to the second ROI, extracting a reference dataset from the second ROI dataset, the reference dataset comprising reference data for the at least one derived characteristic of interest. The method also includes comparing the characteristic dataset to the reference dataset, calculating at least one deviation metric from the comparison, and outputting a visualization of the at least one deviation metric.

In accordance with another aspect of the invention, a system for analyzing clinical image data includes a database having stored thereon clinical image data acquired from a patient and a processor programmed to access a set of data from the database. The processor is also programmed to identify a target ROI from the set of data, extract at least one local feature corresponding to the target ROI from the set of patient data, and define a feature dataset representing the at least one local feature. Further, the processor is programmed to identify a reference ROI from the set of data, extract a reference dataset corresponding to the reference ROI from the set of data, calculate at least one deviation metric for the at least one local feature, the at least one deviation metric representing a deviation of the feature dataset from the reference dataset, and output a visualization of the at least one deviation metric. The system further includes a graphical user interface (GUI) configured to display the at least one deviation metric for the at least one of local feature.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a block diagram of an exemplary data acquisition and processing system in accordance with one embodiment of the present invention.

FIG. 2 is a flowchart illustrating a technique for visualization and analysis of a local feature associated with a clinical image dataset in accordance with one embodiment of the present invention.

FIG. 3 illustrates an exemplary visual representation of deviation data of a local feature of interest derived from a common clinical data set in accordance with one embodiment of the present invention.

FIG. 4 illustrates an exemplary visual representation of deviation data for a feature of interest from an analysis of multiple data points in accordance with another embodiment of the present invention.

FIG. 5 is a flowchart illustrating a technique for visualization and analysis of a local feature associated with a clinical image dataset in accordance with another embodiment of the present invention.

FIG. 6 is a flowchart illustrating a technique for visualization and analysis of a local feature associated with a clinical image dataset in accordance with another embodiment of the present invention.

FIG. 7 illustrates an exemplary visual representation of a GUI for displaying a visualization of deviation data in accordance with one embodiment of the present invention.

### DETAILED DESCRIPTION

In general, an exemplary processor-based system 10 includes a microcontroller or microprocessor 12, such as a central processing unit (CPU), which executes various routines and processing functions of the system 10. For example, the microprocessor 12 may execute various operating system instructions as well as software routines configured to effect certain processes stored in or provided by a manufacture including a computer readable storage medium, such as a memory 14 (e.g., a random access memory (RAM) of a personal computer) or one or more mass storage devices 16 (e.g., an internal or external hard drive, a solid-state storage device, CD-ROM, DVD, or other storage device). In addition, microprocessor 12 processes data provided as inputs for various routines or software programs, such as data provided in conjunction with the present techniques in computer-based implementations.

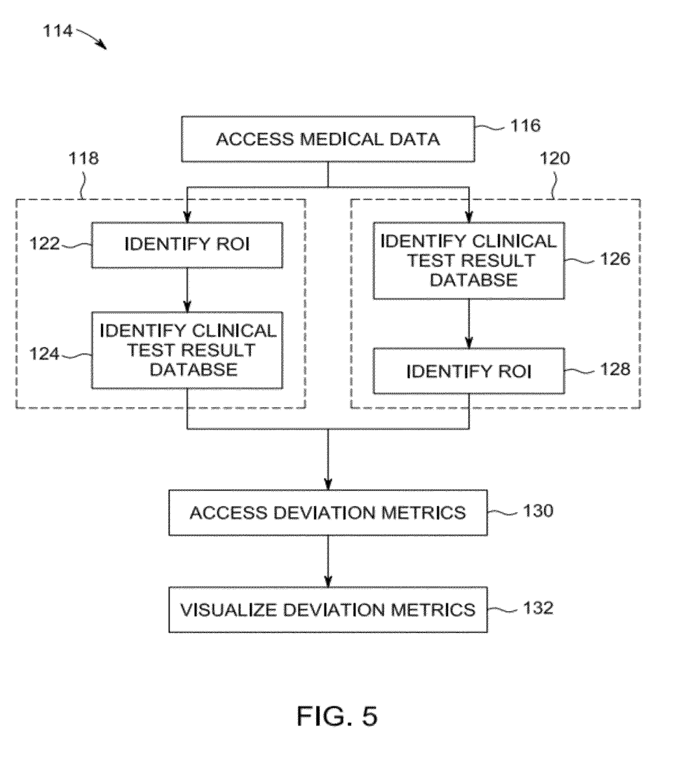

According to various embodiments, system 10 accesses a set of clinical data acquired from and/or corresponding to a region of interest of a patient as well as a set of reference clinical data, as described in more detail below. The clinical data may include image data acquired from one or more imaging systems of various modalities, such as an X-ray system, an ultrasound imaging system, a computed tomography (CT) imaging system, a magnetic resonance (MR) imaging system, a positron emission tomography (PET) imaging system, and a single photon emission computed tomography (SPECT) imaging system, as examples. The clinical data may also include data related to clinical tests, as described in detail with respect to FIG. 5. System 10 may also include one or more databases, such as optional databases 18 and 20 (shown in phantom) for storing data, such as data collected by an optional data acquisition system 22 (shown in phantom) and data used by or generated from microprocessor 12, including both patient data and reference data, as discussed in greater detail below. Additionally, data processing system 10 may receive data directly from optional data acquisition system 22, from databases 18 and 20, or in any other suitable fashion.

Alternatively, such data may be stored in, or provided by, memory 14 or mass storage device 16 or may be provided to microprocessor 12 via one or more input devices 24. As will be appreciated by those of ordinary skill in the art, input devices 24 may include manual input devices, such as a keyboard, a mouse, or the like. In addition, input devices 24 may include a network device, such as a wired or wireless Ethernet card, a wireless network adapter, or any of various ports or devices configured to facilitate communication with other devices via any suitable communications network, such as a local area network or the Internet. Through such a network device, system 10 may exchange data and communicate with other networked electronic systems, whether proximate to or remote from system 10. It will be appreciated that the network may include various components that facilitate communication, including switches, routers, servers or other computers, network adapters, communications cables, and so forth.

Results generated by microprocessor 12, such as the results obtained by processing data in accordance with one or more stored routines, may be stored in a memory device, such as memory 14 or mass storage device 16, may undergo additional processing, or may be provided to an operator via one or more output devices, such as a display 26 and/or a printer 28. Also, based on the displayed or printed output, an operator may request additional or alternative processing or provide additional or alternative data, such as via input device 24. As will be appreciated by those of ordinary skill in the art, communication between the various components of processor-based system 10 may typically be accomplished via a chipset and one or more busses or interconnects which electrically connect the components of system 10. Notably, in certain embodiments of the present techniques, processor-based system 10 may be configured to facilitate patient diagnosis, as discussed in greater detail below.

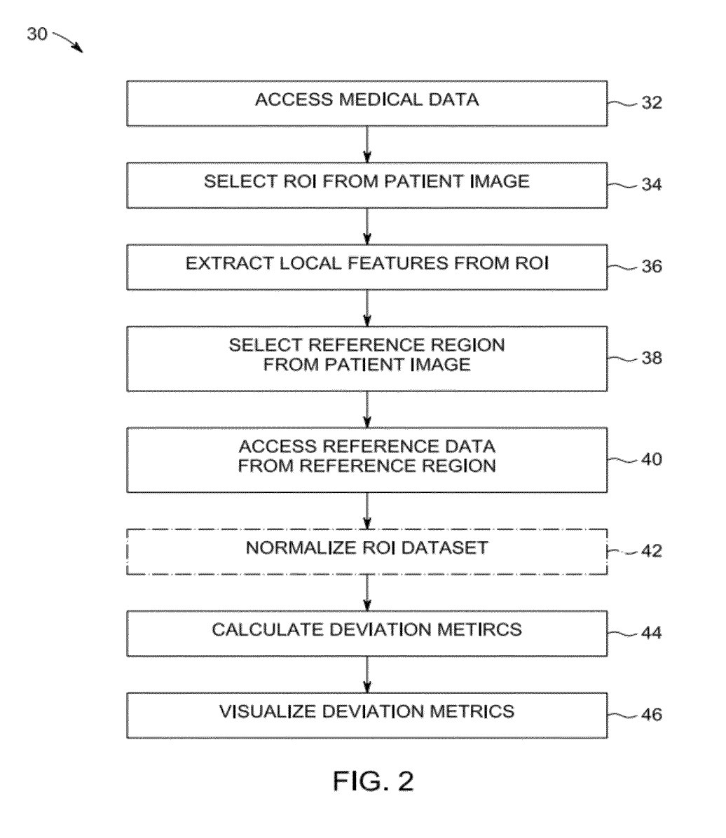

Referring to FIG. 2, a technique 30 is set forth for visualization and analysis of a target clinical region of interest (ROI) within a medical image data set, in accordance with an embodiment of the present invention. As used herein, ROI means any multi-dimensional area of interest, such as, for example, an area or a volume. At step 32, technique 30 accesses medical image data acquired from a patient. The medical data may include image data acquired during a single scan of a patient or during a series of patient scans using any number of data acquisition systems, such as, for example, an X-ray system, an ultrasound system, a CT system, an MR system, a PET system, and/or a SPECT system.

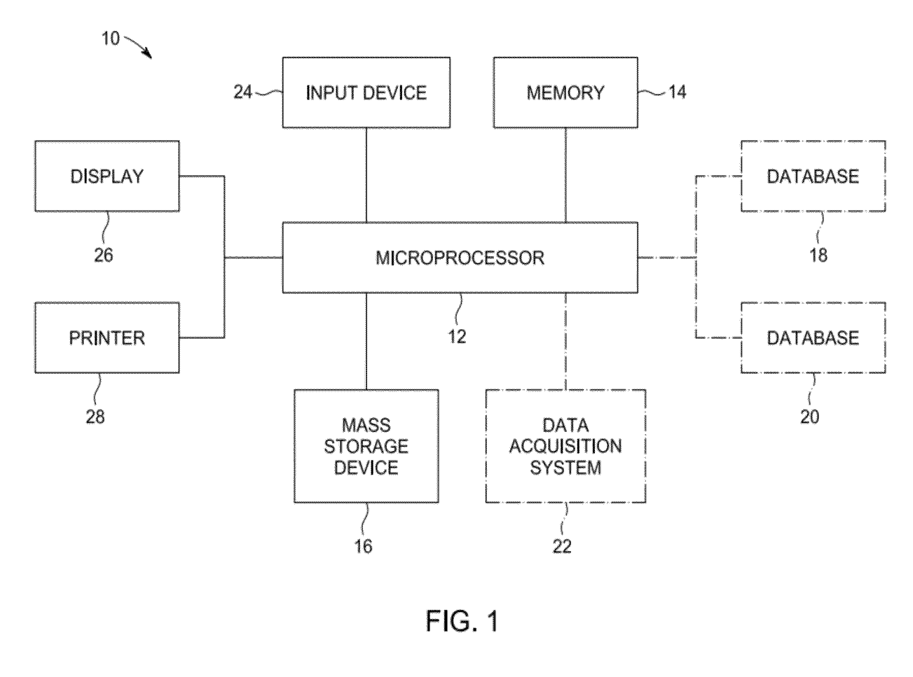

Technique 30 selects one or more ROIs from the medical image data at step 34. Each ROI may be selected manually, semi-automatically, or automatically according to various embodiments using any combination of available image manipulation tools such as ROI selection, registration, segmentation, contouring, etc. For example, a clinician may select an ROI using an input device (e.g., input device 24 of FIG. 1) by drawing a contour around the ROI in an image of the patient on a display (e.g., display 26 of FIG. 1). As another example, an ROI may be identified using an automated or semi-automated algorithm.

At step 36, one or more local features or characteristics of interest are identified and data corresponding to the local feature(s) of interest is extracted from each clinical ROI. Such data is extracted by performing a quantitative analysis on the image data. Local features represent different parameters of the medical image dataset corresponding to the clinical ROI. For example, for a given ROI, local features may include any number of shape-based parameters (e.g., corners, roundness, symmetry, orientation, eccentricity, center of mass, boundaries, moments, etc.), size-based parameters (e.g., perimeter, area, max/min radii, etc.), and/or material- or texture-based parameters (e.g., edge-ness, homogeneity, adjacency, edge density, extreme density, texture transforms, etc.). Further, local features may correspond to any anatomical features or functional features present within image data. Local features may be extracted manually, semi-automatically, or automatically from the clinical ROI, according to various embodiments.

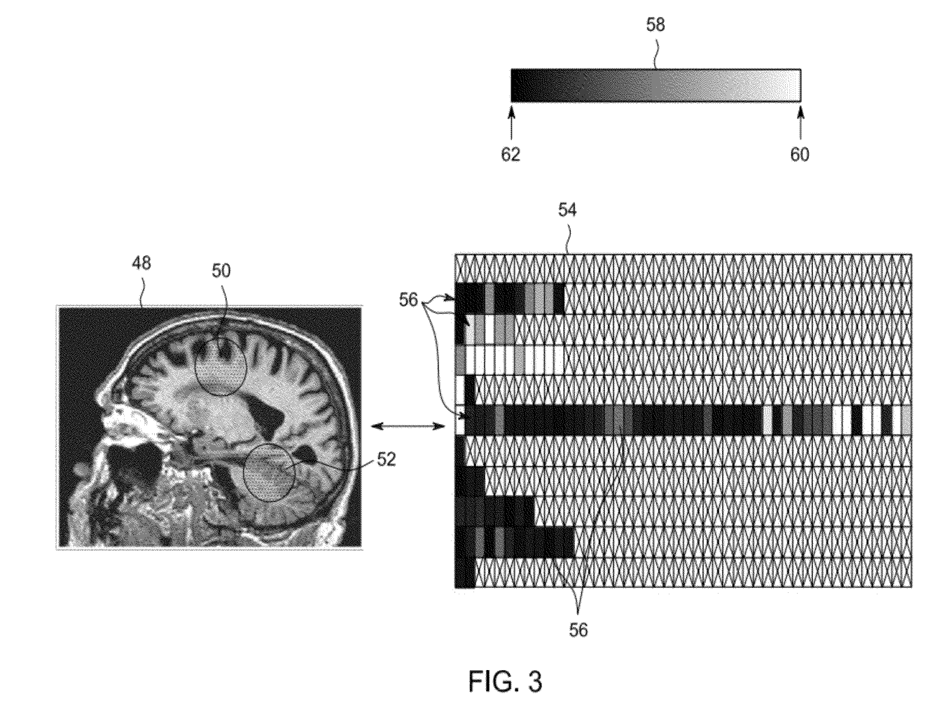

At step 38, a reference region is selected from a patient image by a user as part of the data analysis process. As with the ROI, the reference region may be selected manually, semi-automatically, or automatically. The reference region may correspond to one or several sub-portions of image data from the same set of patient medical image data from which the ROI was selected. According to one embodiment, the reference region and ROI are selected from a common image, as described with respect to FIG. 3. Alternatively, the reference region may be selected from a different image acquired during the same series of patient scans as the image from which the ROI was selected. In such an embodiment, the reference region is selected to cover a region of anatomy of the patient that does not overlap the anatomy corresponding to the ROI. That is, the ROI and reference region are mutually exclusive. In either embodiment, the reference region is selected to correspond to the local features and represents baseline information for each local feature. For example, the reference region may be selected to represent healthy or normal anatomy.

Technique 30 extracts reference data corresponding to the features of interest from the reference region at step 40 in a similar manner as described with respect to step 36. Optionally, at step 42 (shown in phantom) feature data corresponding to the ROI is standardized and normalized to the reference data.

At step 44, technique 30 calculates one or more deviation metrics to represent the deviation between the patient data and the reference data. The deviation metric captures the extent of the deviation of the extracted local features with respect to the reference data. This analysis may be performed on a single ROI within the patient data set or on multiple ROIs for each extracted local feature. In the single ROI example, the extracted local features corresponding to the ROI is compared against the reference dataset. The extent of the deviation from the expected behavior based on the reference is calculated. In the multiple ROI example, data corresponding to the extracted local features from both ROIs is compared against one or more reference datasets. For example, an analysis may compare extracted local features of ROIs representing several cysts of interest to corresponding local features of a dataset acquired from a number of reference cysts to determine whether the cysts of interest are made up of a different material than the reference cysts.

Any number of techniques may be applied to calculate metrics that express the deviation of the extracted local features with respect to the reference dataset. For example, according to one embodiment, a z-score deviation of a local characteristic of interest is calculated with respect to a set of reference result values as follows:

$${z}_{i} = \frac{{x}_{i} - {μ}_{n}}{{σ}_{n}} , \qquad Eqn . 1$$

where z represents the z-score, x represents the raw patient data to be standardized, μ represents the mean of the reference data, and σ represents the standard deviation of the reference data.

At step 46, technique 30 outputs a visualization of the deviation of the extracted local features, as described in more detail with respect to FIGS. 3, 4, and 7.

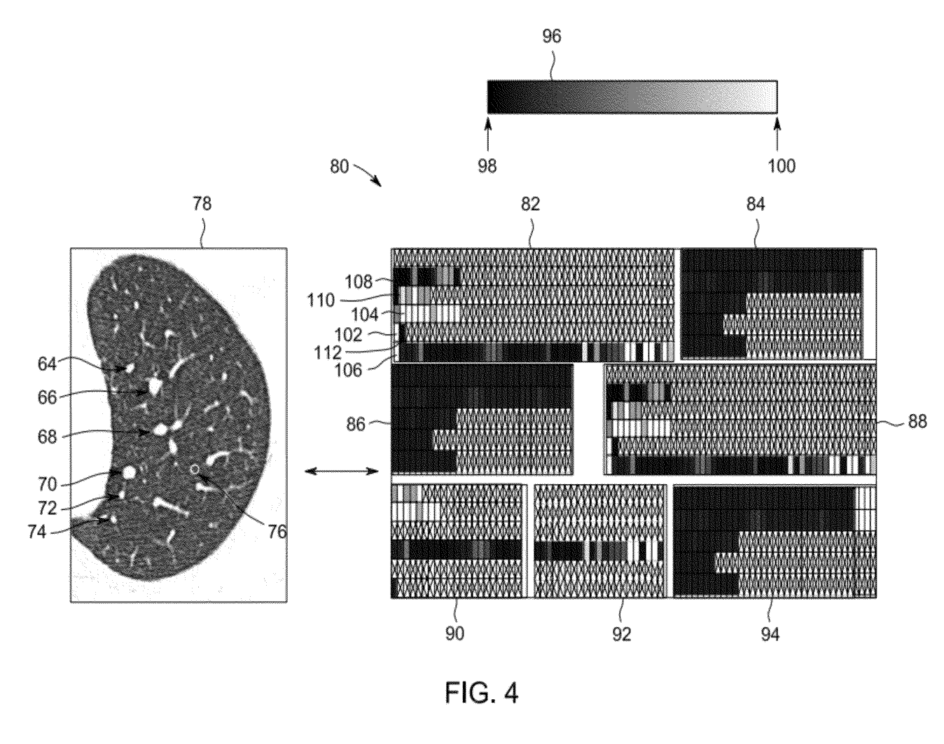

Embodiments for selecting a ROI and corresponding reference data and visualizing the deviation of extracted local features are illustrated in FIGS. 3 and 4. FIG. 3 illustrates an image 48 acquired from a patient of interest, according to one embodiment. Image 48 may be a two-dimensional, three-dimensional, or four-dimensional image, acquired from any type of data acquisition system according to various embodiments, such as data acquisition system 22 of FIG. 1 for example. An ROI 50 is selected within image 48. As shown, ROI 50 highlights a region of the image, such as a region that includes a brain tumor being monitored in the treatment of a cancer patient, for example. Alternatively, ROI 50 may correspond to a region in an image that a clinician believes may include abnormal anatomy based on a visual inspection of the image. A number of local features are associated with ROI 50 such as shape-based parameters and/or texture-based parameters, for example.

A reference region 52 is selected within image 48 having similar local features as those local features present within ROI 50. As an example, reference region 52 may contain similar tissue as ROI 50 and may be selected from a region of tissue having local features that appear normal to a clinician. Alternatively, reference region 52 may be selected from similar anatomy as ROI 50. For example, ROI 50 and reference region 52 both correspond to regions of the brain, as shown in FIG. 3.

Also shown in FIG. 3 is a patient deviation map 54 representing a deviation between the local features of ROI 50 and corresponding local features of reference region 52. Each cell 56 within map 54 corresponds to a different local feature of ROI 50 and is coded based on deviation of the local feature from the reference data. According to one embodiment, a common color scale 58 is applied to the local feature data within map 54 to normalize the scaled values to one another such that deviation may be compared across local features. Thus, local features that deviate greatly from the reference data are displayed at a first end 60 of color scale 58 while local features that closely correlate to the reference data are displayed at a second end 62 of color scale 58, opposite first end 60.

Referring now to FIG. 4, an alternative embodiment of the present invention is illustrated in which multiple regions of interest (ROIs) 64, 66, 68, 70, 72, 74, 76 are selected within an image 78. As one example, ROIs 64-74 are defined as three-dimensional cylinders representing bronchi and ROI 76 is defined as a sphere representing a nodule identified in an image of a patient's lung. ROIs 64-76 may be selected by a clinician or may be selected using an automated or semi-automated algorithm, according to alternative embodiments.

FIG. 4 also illustrates a combined deviation map 80 that includes a deviation map 82, 84, 86, 88, 90, 92, 94 corresponding to each ROI 64-76. Deviation maps 82-94 represent the deviation of local features of respective ROIs 64-76 with respect to corresponding local features of reference data. The deviation of the local features may be calculated based on a comparison of the image data corresponding to ROIs 64-76 with a set of reference data that includes image data representing local features of bronchi and nodules acquired from the patient. For example, the reference data may correspond to image data representing regions in a contralateral lung of the patient, or may correspond to data representing non-overlapping anatomy in a consecutively acquired image. Alternatively, the reference data may represent regions in image 78, similar to region 52 of FIG. 3.

The deviation of the local features is represented in maps 82-94 in a similar manner as described with respect to FIG. 3. That is, individual cells of maps 82-94, each representing a deviation of a respective local feature, are coded using a common color scale 96. Cells coded to correspond to one extreme 98 of color scale 96 represent a minimal deviation from the reference, while cells coded to correspond to the other extreme 100 of color scale 96 represent a significant deviation from the reference.

As an example, assume map 82 represents a deviation of local features of the bronchi selected as ROI 64 with respect to corresponding local features of healthy bronchi in the patient. Cells 102, 104, 106 of map 82 are coded to correspond to extreme 100 of color scale 96. Therefore, cells 102-106 indicate the local features associated with these cells significantly deviate from the corresponding local features of the reference population. Cells 108, 110, 112, on the other hand, are coded to correspond to extreme 98 of color scale 96. Therefore, cells 108-112 indicate the local features associated with these cells have values similar to the reference data.

By combining deviation maps 82-94 into one common display, a clinician is able to quickly visually identify a number of ROIs to investigate in further detail. For example, deviation maps 84, 86, 92, 94, which correspond to ROIs 66, 68, 74, 76, respectively, illustrate minimal deviation between respective ROIs and reference data. Deviation maps 82, 88, 90, on the other hand, illustrate significant deviation between respective ROIs 64, 70, 72 and reference data for a number of features of interest. Such deviation may indicate abnormalities within ROIs 64, 70, 72.

While embodiments illustrated in FIGS. 3 and 4 are discussed with reference to ROIs relating to the brain and lungs, one skilled in the art will recognize that the techniques set forth herein may analyze and visualize any type of anatomy.

Accordingly, a technique is set forth that provides a visual method for analyzing local features derived from one or more selected ROI within an image dataset by comparing local features from the ROI to corresponding local features in a reference dataset. Such a technique affords a clinician the opportunity to perform a digital biopsy of sorts on a ROI in an image. One skilled in the art will recognize that embodiments of the technique may also be applied to analyze the local features of interest with respect to multiple reference datasets to identify similarities and differences between the ROI and the respective reference datasets. For example, local features corresponding to texture-based parameters of an ROI in an image of a patient's brain may be compared corresponding local features of “healthy” tissue within the patient. The resulting deviation maps may then be used as an aide in patient diagnosis.

FIG. 5 illustrates an alternative embodiment of the present invention that includes a technique 114 that associates a given ROI with results acquired from one or more clinical tests that correspond to the given ROI. At step 116, technique 114 accesses medical data, including image data and clinical test data, acquired from a patient. The image data may include data acquired during a single scan of a patient or a series of patient scans using any number of data acquisition systems, such as, for example, an X-ray system, an ultrasound system, a CT system, an MR system, a PET system, and/or a SPECT system. The clinical test data includes patient-specific data representing results of clinical tests, such as, for example, blood tests, heart rate, dementia rating, functional assessment questionnaires, neurological tests, and mental state exams.

After accessing the patient medical data, technique 114 follows either of a first path 118 and a second path 120 to identify at least one ROI and a clinical test result dataset associated with the ROI(s). In the first path 118, the clinical test result dataset is identified based on the ROI identified in the medical image data. Specifically, at step 122 an ROI is selected from the medical image data. The ROI may be selected manually, semi-automatically, or automatically, according to various embodiments. At step 124, technique 114 identifies a clinical test result database based on the selected ROI. In such an embodiment, a predefined map may be applied to the clinical test results to identify clinical test results corresponding to clinical tests associated with the ROI. For example, certain clinical tests are known to correspond to different regions of the brain based on the functional characteristics of the brain regions. Therefore, if the ROI is selected as a specific region of a patient's brain (e.g., the parietal lobe), then the technique may filter the clinical test results to identify results from a clinical test (e.g., a clinical dementia rating) specific to that region with the ROI.

In the second path 120, on the other hand, an ROI is identified from the medical image data based on a selected or available clinical test result dataset. At step 126 a clinical test result database is identified and at step 128 an ROI is identified corresponding to the medical image data based on the selected clinical test result database. For example, the ROI may be identified as a region corresponding in general to the types of clinical tests that the clinical test result dataset are associated with. Alternatively, the ROI may be identified to represent a region of anatomy associated with a clinical test result within the clinical test result dataset that deviates significantly from normal behavior or an expected result. As one example, technique 114 may identify the clinical test result of the patient that deviates from the reference more than any of the other clinical tests as a hot clinical test and define the ROI as a region of anatomy associated with that hot clinical test.

At step 130, a test result deviation map is identified that is indicative of one or more deviations between the clinical test result dataset and a reference dataset of clinical test results. The reference dataset of clinical test results includes test results associated with expected test results acquired from a reference population, such as test results representing normal or abnormal behavior, for example, and/or known clinical values. According to one embodiment, the test result deviation map is a precomputed map that is stored on a database or a mass storage device, such as any of devices 16, 18, or 20 of FIG. 1. Alternatively, the test result deviation map may be calculated as part of technique 114 based on a comparison between the patient-specific clinical test result database and stored clinical test result reference data, in a similar manner as described with respect to step 44 of FIG. 2.

At step 132, technique 114 outputs a visualization of the deviation of the patient's clinical test results from the reference results, in a similar manner as described with respect to FIGS. 3 and 4. According to one embodiment, the visualization includes the one or more ROIs highlighted on a synthetic representation of the patient's anatomy.

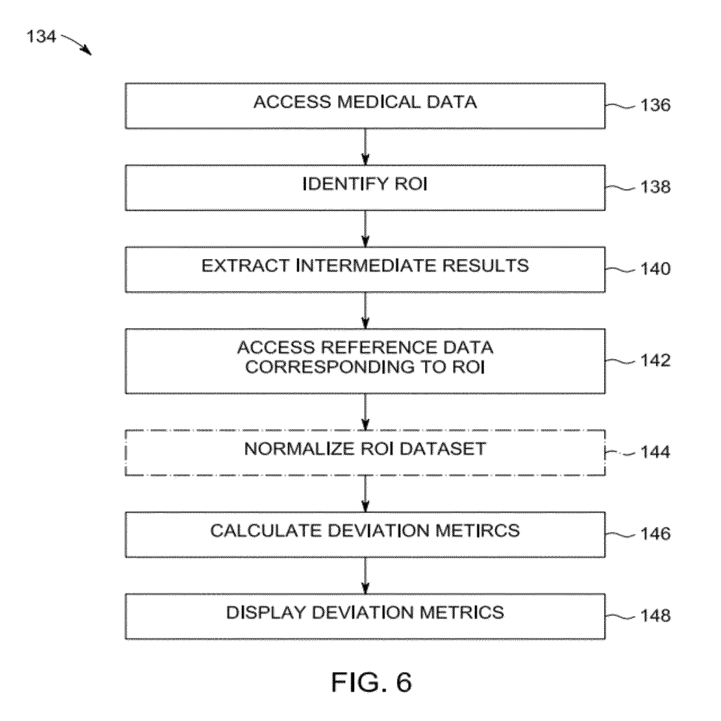

Embodiments of the invention set forth herein may also be applied to intermediate results generated by a data mining or learning machine algorithm used for clinical decision support, as set forth with respect to technique 134 of FIG. 6. Technique 134 begins by accessing medical image data acquired from a patient at step 136, in a similar manner as described with respect to step 32 of FIG. 2. At step 138, a target ROI or ROI dataset is identified. According to various embodiments, the ROI may be identified manually, such as by a user drawing a contour on an image, semi-automatically, such as through a user interaction with decision-making steps of an algorithm, or automatically through the use of an automated algorithm. For example, an automated algorithm may be used to identify the target ROI for disease detection.

An automated algorithm analyzes image data corresponding to the ROI at step 140 and extracts a number of intermediate results. Intermediate results may be parameters derived from the learning algorithm prior to steps like feature reduction, for example. The intermediate results may represent parameters used for disease staging or differential diagnosis, for example. Or, in embodiments where the automated algorithm is used to identify the ROI, the intermediate results may represent an input or an output of intermediate calculations used by the automated algorithm to identify the ROI. In such cases, the intermediate results from applying the automated algorithm to an ROI in a patient dataset are treated in a similar manner as the extracted local features discussed with respect to technique 30.

Technique 134 accesses reference data corresponding to the ROI at step 142. According to one embodiment, technique 134 accesses reference data corresponding to a set of precomputed reference data, such as known values acquired from normal or abnormal anatomy acquired from a reference population. Alternatively, technique 134 accesses reference data by defining a reference ROI from the patient's medical image data in a similar manner as described with respect to step 38 of FIG. 2. Optionally, at step 144 (shown in phantom) data corresponding to the ROI is standardized and normalized to the reference data.

At step 146, technique 134 calculates deviation metrics based on a comparison between the patient's medical image data and the reference data. Thus, intermediate results derived from running a learning algorithm on the ROI may be compared against an associated set of intermediate results derived from running the learning algorithm on a reference data set. Deviation metrics are derived from the comparison of each intermediate result in a similar manner as described with respect to FIG. 2 and are be displayed to a user as one or more deviation maps at step 148, similar to deviation map 54 (FIG. 3) and maps 82-94 (FIG. 4).

The resulting deviation map provides the user with an ‘inside look’ into the parameters leveraged by the learning algorithm and allows the user to gain insights and interact with the inner workings of the algorithm, essentially enabling a visual-based data mining approach. Such an approach provides a key advantage over a typical “black-box” automated approach to decision support that often involves significant validation work. Further, knowledge of the deviation metrics associated with particular intermediate results may be used to ‘tune’ different parameters used in an automated algorithm. For example, a given algorithm parameter may be adjusted such that a deviation metric calculated from a comparison between known normal and known abnormal data indicates a desired amount of deviation. Alternatively, knowledge of one or more deviation metrics may be used to modify the automated algorithm such that the intermediate result approximates the reference parameter.

For example, referring again to FIG. 4, assume ROIs 64, 70, 72 were identified by an automated algorithm as corresponding to abnormal anatomy, while ROIs 66, 68, 74, 76 were identified by the automated algorithm as corresponding to normal anatomy. A user may apply technique 134 to generate deviation maps 82-94 to represent the algorithm's intermediate results. By comparing the deviation of given intermediate result of a ROI indicated as being normal (e.g., ROI 66) with a corresponding intermediate result of a ROI indicated by the algorithm as ‘abnormal’ (e.g., ROI 64), the user can glean insights into the inner workings of the algorithm and gain understanding about the algorithm's decision-making process.

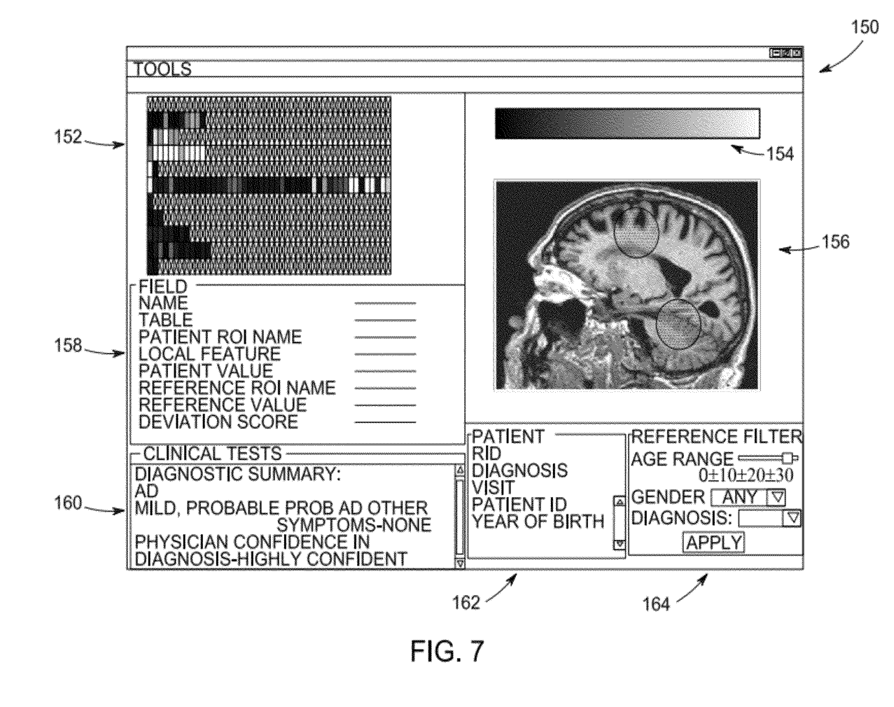

In some embodiments, the visual representations output at step 46 (FIG. 2), step 132 (FIG. 5), and step 148 (FIG. 6) may be displayed on a graphical user interface (GUI) 150 as illustrated in FIG. 7. GUI 150 includes a region 152 for visualization of deviation maps, such as deviation map 54 (FIG. 3). A common color scale 154, similar to scale 58 (FIG. 3) and scale 96 (FIG. 4) is also provided to give meaning to the coding of the cells in the deviation map. GUI 150 also includes a region 156 for visualization of patient image data, such as image 48 (FIG. 3), image 78 (FIG. 4), or a synthetic representation or model atlas, as examples. A number of data regions 158, 160, 162, 164 are also included in GUI 50 to display numeric and textual data, according to various embodiments, including patient image data, reference image data, deviation scores, clinical tests, patient-specific data, reference-specific data, as examples. Optionally, one or more of regions 158-164 may be configured as a control panel to permit a user to input and/or select data through input fields, dropdown menus, etc. It is noted that the arrangement of GUI 150 is provided merely for explanatory purposes, and that other GUI arrangements, field names, and visual outputs may take different forms. Additional display techniques may also include temperature gauges, graphs, dials, font variations, annotations, and the like.

A technical contribution for the disclosed method and apparatus is that is provides for a computer implemented system and method for analyzing and visualizing local clinical features.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Therefore, in accordance with one embodiment, a computer readable storage medium has stored thereon a computer program that includes instructions, which, when executed by a computer, cause the computer to access a medical image dataset acquired from a patient and identify a first ROI from the medical image dataset. The instructions also cause the computer to extract a feature dataset representing a feature of interest specific to the ROI, identify a second ROI from the medical image dataset, and extract a reference dataset comprising reference data representing an expected behavior of the feature of interest. Further, the instructions cause the computer to compare the feature dataset to the reference dataset, generate a deviation metric representing a deviation of the feature of interest based on the comparison, and create a visual representation of the deviation metric.

In accordance with another embodiment, a method includes the steps of accessing a clinical image dataset comprising image data acquired from a patient, identifying a first ROI from the clinical image dataset, and defining a first ROI dataset comprising image data corresponding to the first ROI. The method also includes the steps of extracting at least one derived characteristic of interest corresponding to the first ROI from the first ROI dataset, defining a characteristic dataset comprising image data representing the at least one derived characteristic of interest, and identifying a second ROI from the clinical image dataset. The method further includes the steps of defining a second ROI dataset comprising image data corresponding to the second ROI, extracting a reference dataset from the second ROI dataset, the reference dataset comprising reference data for the at least one derived characteristic of interest. The method also includes comparing the characteristic dataset to the reference dataset, calculating at least one deviation metric from the comparison, and outputting a visualization of the at least one deviation metric.

In accordance with yet another embodiment, a system for analyzing clinical image data includes a database having stored thereon clinical image data acquired from a patient and a processor programmed to access a set of data from the database. The processor is also programmed to identify a target ROI from the set of data, extract at least one local feature corresponding to the target ROI from the set of patient data, and define a feature dataset representing the at least one local feature. Further, the processor is programmed to identify a reference ROI from the set of data, extract a reference dataset corresponding to the reference ROI from the set of data, calculate at least one deviation metric for the at least one local feature, the at least one deviation metric representing a deviation of the feature dataset from the reference dataset, and output a visualization of the at least one deviation metric. The system further includes a GUI configured to display the at least one deviation metric for the at least one of local feature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer readable storage medium having stored thereon a computer program comprising instructions, which, when executed by a computer, cause the computer to:
access a medical image dataset acquired from a patient;
identify a first region of interest (ROI) from the medical image dataset;
extract a feature dataset representing a feature of interest specific to the ROI;
identify a second ROI from the medical image dataset;
extract a reference dataset comprising reference data representing an expected behavior of the feature of interest for the second ROI;
compare the feature dataset to the reference dataset;
generate a deviation metric representing a devation of the feature of interest based on the comparison; and
create a visual representation of the deviation metric.

2. The computer readable storage medium of claim 1 wherein the instructions cause the computer to identify the first and second ROIs from image data representing a common image.

3. The computer readable storage medium of claim 1 wherein the instructions cause the computer to:
identify the first ROI to correspond to a first region of anatomy of the patient; and
identify the second ROI to correspond to a second region of anatomy of the patient, the second region of anatomy noninclusive of any portion of the first region of anatomy.

4. The computer readable storage medium of claim 1 wherein the instructions further cause the computer to extract the feature dataset to represent one of a shape-based parameter, a size-based parameter, a texture-based parameter, and a material-based parameter.

5. The computer readable storage medium of claim 1 wherein the instructions further cause the computer to extract the feature dataset to represent one of an anatomical feature and a functional feature of the first ROI.

6. The computer readable storage medium of claim 1 wherein the instructions further cause the computer to standardize and normalize the feature dataset to the reference dataset.

7. A method comprising:
accessing a clinical image dataset comprising image data acquired from a patient;
identifying a first region of interest (ROI) from the clinical image dataset;
defining a first ROI dataset comprising image data corresponding to the first ROI;
extracting at least one derived characteristic of interest corresponding to the first ROI from the first ROI dataset;
defining a characteristic dataset comprising image data representing the at least one derived characteristic of interest;
identifying a second ROI from the clinical image dataset;
defining a second ROI dataset comprising image data corresponding to the second ROI;
extracting a reference dataset from the second ROI dataset, the reference dataset comprising reference data for the at least one derived characteristic of interest;
comparing the characteristic dataset to the reference dataset;
calculating at least one deviation metric from the comparison; and
outputting a visualization of the at least one deviation metric.

8. The method of claim 7 comprising identifying the first ROI and the second ROI from image data representing a common image.

9. The method of claim 7 comprising:
identifying the first ROI to correspond to a first region of anatomy of the patient; and
identifying the second ROI to correspond to a second region of anatomy of the patient, the second region of anatomy noninclusive of any portion of the first region of anatomy.

10. The method of claim 7 wherein identifying the first ROI comprises identifying image data corresponding to abnormal characteristics of interest; and
wherein identifying the second ROI comprises identifying image data corresponding to normal characteristics of interest.

11. The method of claim 7 wherein extracting the at least one derived characteristic of interest comprises deriving at least one of an anatomical characteristic and a functional characteristic of the first ROI.

12. The method of claim 7 wherein extracting the at least one derived characteristic of interest comprises deriving at least one of a shape-based parameter, a size-based parameter, a texture-based parameter, and a material-based parameter of the first ROI.

13. The method of claim 7 further comprising displaying the visualization of the at least one deviation metric as a color-coded grid.

14. The method of claim 7 further comprising standardizing and normalizing the characteristic dataset based to the reference dataset.

15. A system for analyzing clinical image data comprising:
a database having stored thereon clinical image data acquired from a patient;
a processor programmed to:
access a set of data from the database;
identify a target region of interest (ROI) from the set of data;
extract at least one local feature corresponding to the target ROI from the set of patient data;
define a feature dataset representing the at least one local feature;
identify a reference ROI from the set of data;
extract a reference dataset corresponding to the reference ROI from the set of data;
calculate at least one deviation metric for the at least one local feature, the at least one deviation metric representing a deviation of the feature dataset from the reference dataset; and
output a visualization of the at least one deviation metric; and
a graphical user interface (GUI) configured to display the at least one deviation metric for the at least one of local feature.

16. The system of claim 15 wherein the processor is further programmed to identify the target ROI and the reference ROI from image data representing a common image.

17. The system of claim 15 wherein the processor is further programmed to:
identify the target ROI to correspond to a first region of anatomy; and
identify the reference ROI to correspond to a second region of anatomy, the second region of anatomy noninclusive of any portion of the first region of anatomy.

18. The system of claim 15 wherein the GUI comprises a visualization of the at least one deviation metric as a coded grid.

19. The system of claim 18 wherein the GUI further comprises an image of the target ROI and the reference ROI.

20. The system of claim 15 wherein the database comprises image data acquired from the patient in a consecutive series of scans.
